(19) United States
(12) Patent Application Publication
(10) Pub. No.: US 2026/0186692 A1
(43) Pub. Date: Jul. 2, 2026

(54) DATA WRITING METHOD, FLASH MEMORY DEVICE, AND COMPUTER-READABLE STORAGE MEDIUM

(71) Applicant: DapuStor Corporation, Shenzhen (CN)

(72) Inventors: Xiaopeng LIU, Shenzhen (CN); Hui ZHOU, Shenzhen (CN); Bin LI, Shenzhen (CN)

(73) Assignee: DapuStor Corporation, Shenzhen (CN)

(21) Appl. No.: 19/385,253

(22) Filed: Nov. 11, 2025

(30) Foreign Application Priority Data
Dec. 26, 2024 (CN) 202411940396.8

(51) Int. Cl. G06F 3/06

(52) U.S. Cl. CPC G06F 3/0655; G06F 3/0604; G06F 3/0679

(57) ABSTRACT

A data writing method, a flash memory device, and a computer-readable storage medium are provided. The method includes acquiring user data distributed from a host and storing the user data in the first cache space. The method includes writing the user data in the first cache space into the flash memory space. The method includes caching the user data in the second cache space after the user data is written into the flash memory space. The method further includes smoothing a write bandwidth of the flash memory space to obtain an average write bandwidth of the flash memory space. The method further includes determining a first release bandwidth according to the average write bandwidth of the flash memory space. The first release bandwidth is equal to the average write bandwidth. The method further includes releasing the user data in the second cache space according to the first release bandwidth.

### CROSS-REFERENCE TO RELATED APPLICATION

The present application claims the benefit of priority to Chinese Application No. 202411940396.8, filed on Dec. 26, 2024, the entire contents of which is expressly incorporated herein by reference.

### TECHNICAL FIELD

The present application relates to the field of storage device applications, and in particular to a data writing method, a flash memory device, and a computer-readable storage medium.

### BACKGROUND

Flash memory devices refer to storage devices manufactured based on flash memory technology. A flash is an electronic storage medium that uses electric current to store and read data in semiconductor transistors. For example, NAND flash is a type of flash memory consisting of multiple storage units, each of which can store a data bit (0 or 1). Flash memory devices can be independent storage units, such as USB flash drives and solid-state drives. They can also be storage modules embedded in other devices, such as eMMC or UFS storage in smartphones.

When a host writes user data into the flash memory device, the user data is usually cached by means of the high-speed cache space. Since the writing speed and reading speed of the high-speed cache space are greater than the writing speed of the flash memory space, when the host continuously writes in user data, the high-speed cache space will be filled with the user data written in by the host. Due to the limited size of the high-speed cache space, it is necessary to obtain the cache space by releasing the user data in the high-speed cache space, so that the host can continuously write in user data. As a result, the writing speed of the host is substantially equal to the release speed of the high-speed cache space.

At present, the high-speed cache space is usually released after programming is done for the flash memory space. However, in a block, the duration of programming fluctuates for different word lines, which leads to fluctuation in the release speed of the high-speed cache space, resulting in large fluctuation in the write bandwidth of the host. In addition, due to other data writing operations such as garbage collection inside the SSD, bandwidth fluctuations are further aggravated, resulting in insufficient consistency in the host's write performance, and further resulting in poor quality of service (QoS) of the flash memory device.

### SUMMARY

The embodiments of the present application provide a data writing method to improve the consistency of the write performance of hosts, thereby improving the quality of service of flash memory devices.

In a first aspect, a data writing method applied to a flash memory device is disclosed. The flash memory device includes a high-speed cache space and a flash memory space, and the high-speed cache space includes a first cache space and a second cache space. The first cache space is used to cache user data sent by a host, and the second cache space is used to cache user data written into the flash memory space. The method includes: acquiring user data distributed from the host and storing the user data in the first cache space; writing the user data in the first cache space into the flash memory space; caching the user data in the second cache space after the user data is written into the flash memory space; smoothing a write bandwidth of the flash memory space to obtain an average write bandwidth of the flash memory space; determining a first release bandwidth according to the average write bandwidth of the flash memory space, where the first release bandwidth is equal to the average write bandwidth; and releasing the user data in the second cache space according to the first release bandwidth.

In some embodiments, smoothing the write bandwidth of the flash memory space to obtain the average write bandwidth of the flash memory space includes: counting a volume of data that is successfully written into the flash memory space in a real-time manner; determining a plurality of first write bandwidths corresponding to a plurality of sampling durations at least by: after each sampling duration, counting a data increment of the volume of written data to compute a first write bandwidth corresponding to the sampling duration, where the first write bandwidth is computed by dividing the data increment by the sampling duration; and smoothing the plurality of first write bandwidths by a smoothing algorithm to obtain the average write bandwidth.

In some embodiments, the method further includes: acquiring a current bandwidth of the flash memory space; determining whether the average write bandwidth is less than the current bandwidth of the flash memory space; determining the first release bandwidth to be the average write bandwidth responsive to the average write bandwidth being less than the current bandwidth; and determining the first release bandwidth to be a sum of the current bandwidth and a feedback bandwidth responsive to the average write bandwidth being greater than or equal to the current bandwidth, where the feedback bandwidth is computed by multiplying a first coefficient with a user data space, where the user data space is a size of user data in a second cache space.

In some embodiments, the method further includes: determining the feedback bandwidth according to the user data space, including: setting a water line, where the water line is less than the second cache space; determining whether the user data space is less than or equal to the water line; responsive to the user data space being less than or equal to the water line, setting the feedback bandwidth as zero; and responsive to the user data space being greater than the water line, setting the feedback bandwidth as a result computed by multiplying a second coefficient with a difference of the user data space minus the water line.

In some embodiments, acquiring the user data distributed from the host and storing the user data in the first cache space includes: acquiring a cache application command corresponding to a host write request, where the cache application command corresponds to a currently-to-be-applied space; and according to the cache application command, applying for the currently-to-be-applied space in the high-speed cache space to store the user data in the first cache space, where the first cache space is updated by adding the first cache space that has been applied for caching other user data sent by the host with the currently-to-be applied space.

In some embodiments, after the user data in the second cache space is released, the method further includes: determining a currently released space, where the currently released space is used to compensate the first cache space; when the currently released space is less than the currently-to-be-applied, determining that an execution of the cache application command fails; or when the currently released space is greater than or equal to the currently-to-be-applied space, determining that the execution of the cache application command succeeds.

In some embodiments, the method further includes: determining a smooth state of the flash memory device according to a current situation of the flash memory device and the host, including: determining the smooth state of the flash memory device to be an off state when the current situation meets a first condition, where the first condition is that a write bandwidth of the host is zero, or when the host applies to the high-speed cache space for a cache space, the number of successes is greater than a number of failures or the write bandwidth of the host is less than a target bandwidth of the flash memory device; determining the smooth state of the flash memory device to be a sampling state when the current situation meets a second condition, where the second condition is that the write bandwidth of the host is not zero, and when the host applies to the high-speed cache space for a cache space, the number of successes is less than the number of failures or the write bandwidth of the host is greater than the target bandwidth of the flash memory device; and determining the smooth state of the flash memory device to be an on state when the current situation meets a third condition, where the third condition is that a sampling duration of the sampling state is greater than a preset time threshold.

In some embodiments, the method further includes: switching the smooth state of the flash memory device, including: when the smooth state of the flash memory device is the off state, switching the smooth state of the flash memory device to the sampling state when the current situation meets the second condition; when the smooth state of the flash memory device is the sampling state, switching the smooth state of the flash memory device to the off state when the current situation meets the first condition, or switching the smooth state of the flash memory device to the on state when the current situation meets the third condition; and when the smooth state of the flash memory device is the on state, switching the smooth state of the flash memory device to the off state when the current situation meets the first condition.

In some embodiments, switching the smooth state of the flash memory device further includes: when the smooth state of the flash memory device is the on state, computing a first average write bandwidth of the flash memory space in a first sampling cycle; and computing a second average write bandwidth of the flash memory space in a second sampling cycle, where the second sampling cycle is longer than the first sampling cycle; and when the difference between the first average write bandwidth and the second average write bandwidth is greater than a difference threshold, switching from the on state to the off state.

In a second aspect, a flash memory device includes: a flash memory space; a high-speed cache space including a first cache space and a second cache space, where the first cache space is used to cache user data sent by a host, and the second cache space is used to cache user data written into the flash memory space; a processor; and a memory storing instructions that, when executed by the processor, cause the processor to perform operations. The operations include: acquiring user data distributed from the host and storing the user data in the first cache space; writing the user data in the first cache space into the flash memory space; caching the user data in the second cache space after the user data is written into the flash memory space; smoothing a write bandwidth of the flash memory space to obtain an average write bandwidth of the flash memory space; determining a first release bandwidth according to the average write bandwidth of the flash memory space, where the first release bandwidth is equal to the average write bandwidth; and releasing the user data in the second cache space according to the first release bandwidth.

In some embodiments, smoothing the write bandwidth of the flash memory space to obtain the average write bandwidth of the flash memory space includes: counting a volume of data that is successfully written into the flash memory space in a real-time manner; determining a plurality of first write bandwidths corresponding to a plurality of sampling durations at least by: after each sampling duration, counting a data increment of the volume of written data to compute a first write bandwidth corresponding to the sampling duration, where the first write bandwidth is computed by dividing the data increment by the sampling duration; and smoothing the plurality of first write bandwidths by a smoothing algorithm to obtain the average write bandwidth.

In some embodiments, the operations further include: acquiring a current bandwidth of the flash memory space; determining whether the average write bandwidth is less than the current bandwidth of the flash memory space; determining the first release bandwidth to be the average write bandwidth responsive to the average write bandwidth being less than the current bandwidth; and determining the first release bandwidth to be a sum of the current bandwidth and a feedback bandwidth responsive to the average write bandwidth being greater than or equal to the current bandwidth, where the feedback bandwidth is computed by multiplying a first coefficient with a user data space, where the user data space is a size of user data in a second cache space.

In some embodiments, the operations further include: determining the feedback bandwidth according to the user data space, including: setting a water line, where the water line is less than the second cache space; determining whether the user data space is less than or equal to the water line; responsive to the user data space being less than or equal to the water line, setting the feedback bandwidth as zero; and responsive to the user data space being greater than the water line, setting the feedback bandwidth as a result computed by multiplying a second coefficient with a difference of the user data space minus the water line.

In some embodiments, acquiring the user data distributed from the host and storing the user data in the first cache space includes: acquiring a cache application command corresponding to a host write request, where the cache application command corresponds to a currently-to-be-applied space; and according to the cache application command, applying for the currently-to-be-applied space in the high-speed cache space to store the user data in the first cache space, where the first cache space is updated by adding the first cache space that has been applied for caching other user data sent by the host with the currently-to-be applied space.

In some embodiments, after the user data in the second cache space is released, the operations further include: determining a currently released space, where the currently released space is used to compensate the first cache space; when the currently released space is less than the currently-to-be-applied, determining that an execution of the cache application command fails; or when the currently released space is greater than or equal to the currently-to-be-applied space, determining that the execution of the cache application command succeeds.

In some embodiments, the operations further include: determining a smooth state of the flash memory device according to a current situation of the flash memory device and the host, including: determining the smooth state of the flash memory device to be an off state when the current situation meets a first condition, where the first condition is that a write bandwidth of the host is zero, or when the host applies to the high-speed cache space for a cache space, the number of successes is greater than a number of failures or the write bandwidth of the host is less than a target bandwidth of the flash memory device; determining the smooth state of the flash memory device to be a sampling state when the current situation meets a second condition, where the second condition is that the write bandwidth of the host is not zero, and when the host applies to the high-speed cache space for a cache space, the number of successes is less than the number of failures or the write bandwidth of the host is greater than the target bandwidth of the flash memory device; and determining the smooth state of the flash memory device to be an on state when the current situation meets a third condition, where the third condition is that a sampling duration of the sampling state is greater than a preset time threshold.

In some embodiments, the operations further include: switching the smooth state of the flash memory device, including: when the smooth state of the flash memory device is the off state, switching the smooth state of the flash memory device to the sampling state when the current situation meets the second condition; when the smooth state of the flash memory device is the sampling state, switching the smooth state of the flash memory device to the off state when the current situation meets the first condition, or switching the smooth state of the flash memory device to the on state when the current situation meets the third condition; and when the smooth state of the flash memory device is the on state, switching the smooth state of the flash memory device to the off state when the current situation meets the first condition.

In some embodiments, switching the smooth state of the flash memory device further includes: when the smooth state of the flash memory device is the on state, computing a first average write bandwidth of the flash memory space in a first sampling cycle; and computing a second average write bandwidth of the flash memory space in a second sampling cycle, where the second sampling cycle is longer than the first sampling cycle; and when the difference between the first average write bandwidth and the second average write bandwidth is greater than a difference threshold, switching from the on state to the off state.

In a third aspect, a non-transitory computer-readable storage medium storing instructions is disclosed. The instructions, when executed by a processor, cause the processor to perform a data writing method applied to a flash memory device. The flash memory device includes a high-speed cache space and a flash memory space, and the high-speed cache space includes a first cache space and a second cache space. The first cache space is used to cache user data sent by a host, and the second cache space is used to cache user data written into the flash memory space. The data writing method includes: acquiring user data distributed from the host and storing the user data in the first cache space; writing the user data in the first cache space into the flash memory space; caching the user data in the second cache space after the user data is written into the flash memory space; smoothing a write bandwidth of the flash memory space to obtain an average write bandwidth of the flash memory space; determining a first release bandwidth according to the average write bandwidth of the flash memory space, where the first release bandwidth is equal to the average write bandwidth; and releasing the user data in the second cache space according to the first release bandwidth.

In some embodiments, smoothing the write bandwidth of the flash memory space to obtain the average write bandwidth of the flash memory space includes: counting a volume of data that is successfully written into the flash memory space in a real-time manner; determining a plurality of first write bandwidths corresponding to a plurality of sampling durations at least by: after each sampling duration, counting a data increment of the volume of written data to compute a first write bandwidth corresponding to the sampling duration, where the first write bandwidth is computed by dividing the data increment by the sampling duration; and smoothing the plurality of first write bandwidths by a smoothing algorithm to obtain the average write bandwidth.

The beneficial effects of embodiments of the present application are as follows: Different from the existing art, embodiments of the present application provide a data writing method, which is applied to a flash memory device; the flash memory device includes a high-speed cache space and a flash memory space; the high-speed cache space includes a first cache space and a second cache space; specifically, the first cache space is used to cache user data sent by a host, and the second cache space is used to cache user data written into the flash memory space. The method includes: acquiring user data distributed from a host and storing the user data in the first cache space; writing the user data in the first cache space into the flash memory space; after the user data is written into the flash memory space, caching the user data that has been written into the flash memory space in the second cache space; smoothing a write bandwidth of the flash memory space to obtain an average write bandwidth of the flash memory space; and determining a first release bandwidth according to the average write bandwidth of the flash memory space. Specifically, the first release bandwidth is equal to the average write bandwidth; and releasing the user data in the second cache space according to the first release bandwidth.

According to the data writing method, a second cache space is set in the high-speed cache space to cache user data that has been written into the flash memory space, and an average write bandwidth of the flash memory space is used to determine a release bandwidth of the second cache space, so that the second cache space releases the user data according to the average write bandwidth of the flash memory space. In this way, the bandwidth fluctuation of a host can be smoothed out. The present application can improve the consistency of the write performance of hosts, thereby improving the service quality of the flash memory device.

### BRIEF DESCRIPTION OF THE DRAWINGS

One or more embodiments are exemplarily illustrated by the pictures in the corresponding drawings, and these exemplary illustrations do not constitute a limitation on the embodiments. Elements with the same reference numerals in the drawings represent similar elements, and unless otherwise stated, the figures in the drawings do not constitute a scale limitation.

FIG. 1 is a schematic diagram illustrating the structure of a flash memory device according to embodiments of the present application;

FIG. 2 is a schematic diagram of a duration of programming according to embodiments of the present application.

FIG. 3 is a schematic diagram of a process of writing host data according to embodiments of the present application.

FIG. 4 is a schematic flow chart of a data writing method according to embodiments of the present application.

FIG. 5 is a schematic diagram of the detailed process of Step S401 in FIG. 4.

FIG. 6 is a schematic diagram of another process of writing host data according to embodiments of the present application.

FIG. 7 is a schematic flow chart of a process of determining whether a cache application command corresponding to a host write request is successfully applied for according to embodiments of the present application.

FIG. 8 is a schematic diagram of the detailed process of Step S404 in FIG. 4.

FIG. 9 is a schematic diagram of a process of releasing the cache space according to embodiments of the present application.

FIG. 10 is a schematic diagram of a bandwidth feedback mechanism according to embodiments of the present application.

FIG. 11 is a schematic flow chart of a process of determining a first release bandwidth according to embodiments of the present application.

FIG. 12 is a schematic diagram of a water line according to embodiments of the present application.

FIG. 13 is a schematic flow chart of a process of determining a feedback bandwidth according to embodiments of the present application.

FIG. 14 is a schematic flow chart of a process of determining the smooth state of a flash memory device according to embodiments of the present application.

FIG. 15 is a schematic diagram of a process of switching smooth states according to embodiments of the present application;

FIG. 16 is a schematic diagram illustrating the structure of another flash memory device according to embodiments of the present application.

### REFERENCE NUMERALS

| No. | Description | No. | Description |
|---|---|---|---|
| 100 | Flash memory device | 200 | Host |
| 110 | Flash medium | 120 | Controller |
| 121 | Processor | 122 | Memory |
| 123 | Flash memory controller | 124 | Interface |

### DETAILED DESCRIPTION

To make the objectives, technical solutions, and advantages of this application clearer and more explicit, the following further elaborates on this application in detail with reference to the accompanying drawings and embodiments. It should be understood that the specific embodiments described herein are only used to explain this application and are not intended to limit it. Based on the embodiments of this application, all other embodiments obtained by those of ordinary skill in the art without creative efforts shall fall within the scope of protection of this application.

It should be noted that, if there is no conflict, the various features in the embodiments of this application can be combined with each other, all of which fall within the scope of protection of this application. Additionally, although functional module divisions are made in the device schematic diagram and logical sequences are shown in the flowchart, in some cases, the steps shown or described may be performed in a manner different from the module divisions in the device or the sequence in the flowchart. Furthermore, the terms “first”, “second”, “third”, etc. used in this application do not limit the data and execution order, but merely distinguish between identical or similar items with basically the same function and effect.

The technical solution of the present application will be described in detail below with reference to the drawings in the specification:
a data writing method according to embodiments of the present application, which is applied to flash memory devices, such as U disks, SD cards, microSD cards, CF cards, and solid-state drives (SSDs). A flash memory device is a storage device with a semiconductor flash (NAND flash) as the medium. Its main components include flash media, flash memory controller, and a dynamic random access memory (DRAM). Among them, an important function of the flash memory controller is to perform storage operations as a driver for the flash memory chip. Its main operations include erasing, writing, and reading.

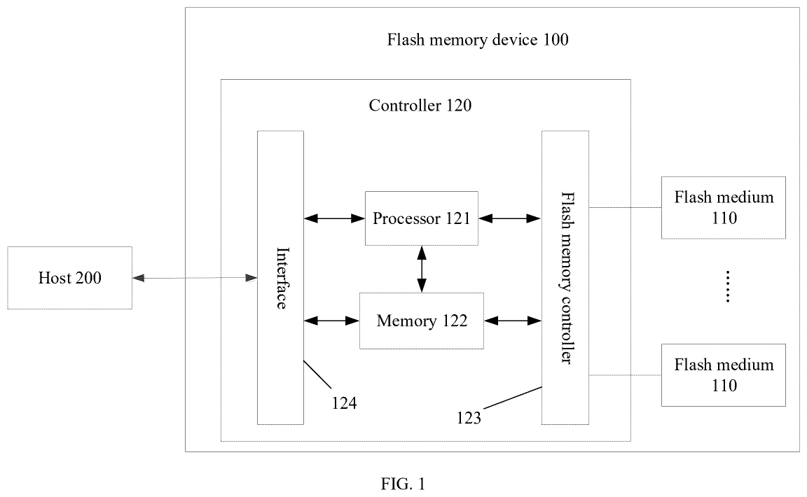

Referring to FIG. 1, FIG. 1 is a schematic diagram illustrating the structure of a flash memory device according to embodiments of the present application.

As shown in FIG. 1, the flash memory device 100 includes flash media 110 and a controller 120 connected to the flash media 110. The flash memory device 100 is communicatively connected with a host 200 in a wired or wireless manner for data interaction.

Each of the flash media 110, as a storage medium of the flash memory device 100, is also called flash, NAND flash, flash memory or flash particle. As memory devices, they are non-volatile memories that can store data for a long time even without current supply. Their storage characteristics are equivalent to those of hard disks, so that the flash media 110 can become the basis of storage media of various portable digital devices.

The controller 120 includes a processor 121, a memory 122, a flash memory controller 123, and an interface 124.

The processor 121 is respectively connected with the memory 122, the flash memory controller 123, and the interface 124, in which the processor 121 can be connected with the memory 122, the flash memory controller 123, and the interface 124 through a bus or other means; the processor is used to run non-volatile software programs, instructions, and modules stored in the memory 122, thereby implementing any method embodiment of the present application. On this basis, through firmware development, it is also used to perform the core processing at the flash translation layer (FTL).

The memory 122 is mainly used to cache read/write instructions sent by the host 200, and read data or write data obtained from the flash media 110 according to the read/write instructions sent by the host 200.

The flash memory controller 123 is connected to the flash media 110, the processor 121, and the memory 122, and is used to access the flash medium 110 at the back end, and manage various parameters and data I/O interfaces of the flash media 110.

The interface 124 is connected to the host 200, the processor 121, and the memory 122, and is used to receive data sent by the host 200 or receive data sent by the processor 121 to facilitate data transmission between the host 200 and the processor 121. The interface 124 can be a SATA-2 interface, a SATA-3 interface, a SAS interface, an MSATA interface, a PCI-E interface, an NGFF interface, a CFast interface, an SFF-8639 interface, or an M.2 NVMe/SATA protocol.

At present, with the development of NAND flash manufacturing technology, the number of stacked layers in a flash is increasing, and the number of pages in a physical block is increasing. For example, a physical block of a mainstream flash includes more than 4,000 pages.

It can be understood that flash programming is carried out by word line, and a word line may contain multiple pages. For example, SLC contains one page; MLC contains 2 pages; TLC contains 3 pages; and QLC contains 4 pages. Therefore, more than 1,000 times of programming are needed for a block that includes more than 4,000 pages. Furthermore, for some NAND flashes, such as QLC NAND flash, two times of programming are needed for the data of a word line, so that more times of programming are needed for a block.

Assuming that the duration of programming for a word line is tProgram, the tProgram is in milliseconds. For example, the tProgram for TLC NAND flash is 1 to 2 ms, and the tProgram for QLC NAND flash is 6 to 9 ms. Therefore, it takes seconds to complete programming for a block. For TLC NAND flash, 1,000 times of programming are needed, and the tProgram is 1.5 ms, so that it will take 1.5 s to complete programming for a block. For QLC NAND flash, 2,000 times of programming are required, and the tProgram is 7 ms, so that it will take 10.5 s to complete programming for a block.

When a host writes user data into the flash memory device, the user data is usually cached by means of the high-speed cache space. Since the writing speed and reading speed of the high-speed cache space are greater than the writing speed of the flash memory space, when the host continuously writes in user data, the high-speed cache space will be filled with the user data written in by the host. Due to the limited size of the high-speed cache space, it is necessary to obtain the cache space by releasing the user data in the high-speed cache space, so that the host can continuously write in user data. As a result, the writing speed of the host is substantially equal to the release speed of the high-speed cache space.

Currently, the high-speed cache space is usually released after programming is done for the flash memory space. However, in a block, the duration of programming fluctuates for different word lines, that is to say, the tProgram fluctuates for different word lines. Taking QLC NAND flash as an example, assuming that a block includes 5544 pages, and two times of programming are needed for each word line.

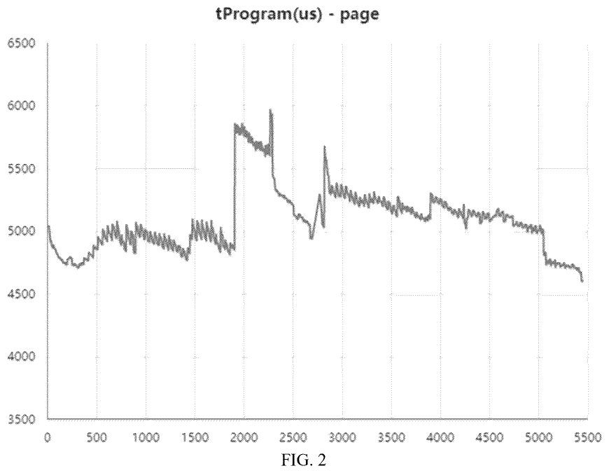

Referring to FIG. 2, FIG. 2 is a schematic diagram of a duration of programming according to embodiments of the present application.

As shown in FIG. 2, the horizontal axis is the number of pages, and the vertical axis is the duration of programming (tProgram). FIG. 2 shows the statistics of the tProgram of second programming, where the tProgram is within 4.6 to 6 ms, resulting in periodic fluctuations, even with a fluctuation range of more than 20%, in the performance bandwidth of the host.

That is to say, in a block, the duration of programming fluctuates for different word lines, which leads to fluctuation in the release speed of the high-speed cache space, resulting in large fluctuation in the write bandwidth of the host. In addition, due to other data writing operations such as garbage collection inside the SSD, bandwidth fluctuations are further aggravated, resulting in insufficient consistency in the host's write performance, and further resulting in poor quality of service of the flash memory device.

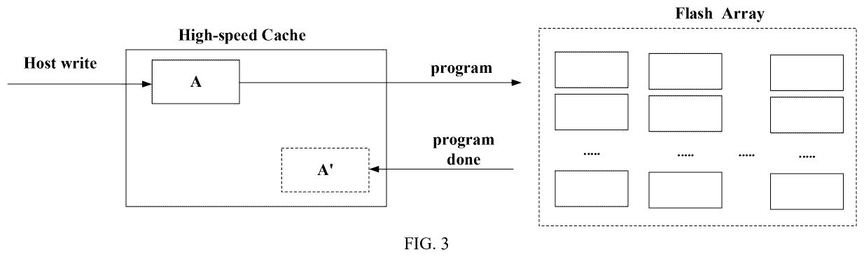

Further referring to FIG. 3, FIG. 3 is a schematic diagram of a process of writing host data according to embodiments of the present application.

As shown in FIG. 3, the host data is written to the high-speed cache space (denoted as cache). For example, the host writes data A into the high-speed cache space (cache), and the high-speed cache space (cache) writes (by programming) the data A into the flash memory space, namely the flash array. After the data A is successfully written into the flash array, data A′ in the high-speed cache space corresponding to the data A is released.

Specifically, the host writes data in the following steps (1) to (3):

Step (1): writing the host data into the high-speed cache space.

For this purpose, the high-speed cache space (cache) includes storage media such as synchronous dynamic random access memory (SDRAM), double data rate synchronous dynamic random access memory (DDRAM), and single-level cell NAND flash (SLC NAND flash).

Step (2): writing the host data into the flash memory space.

Specifically, the data in the high-speed cache space is written into the flash memory space by means of firmware processing. For this purpose, the flash memory space includes the flash array, and the flash array includes storage media such as MLC NAND flash, TLC NAND flash, and QLC NAND flash.

Step (3): releasing the high-speed cache space after the data is successfully written into the flash memory space.

Specifically, after the data A is successfully written to the flash array, the data A′ in the high-speed cache space corresponding to the data A is released.

It can be understood that when the host writes user data into the flash memory device, the user data is usually cached by means of the high-speed cache space. Since the writing speed and reading speed of the high-speed cache space are greater than the writing speed of the flash memory space, when the host continuously writes in user data, the high-speed cache space will be filled with the user data written in by the host. Due to the limited size of the high-speed cache space, it is necessary to obtain the cache space by releasing the user data in the high-speed cache space, so that the host can continuously write in user data. As a result, the writing speed of the host is substantially equal to the release speed of the high-speed cache space.

The method described above is to release the high-speed cache space when programming is done after the data is successfully written into the flash memory space. However, in a block, the duration of programming fluctuates for different word lines, which leads to fluctuation in the release speed of the high-speed cache space, resulting in large fluctuation in the write bandwidth of the host. In addition, due to other data writing operations such as garbage collection inside the SSD, bandwidth fluctuations are further aggravated, resulting in insufficient consistency in the host's write performance, and further resulting in poor quality of service (QoS) of the flash memory device.

Based on this, embodiments of the present application provide a data writing method, in which a second cache space is set in the high-speed cache space to cache user data that has been written into the flash memory space, and an average write bandwidth of the flash memory space is used to determine a release bandwidth of the second cache space, so that the second cache space releases the user data according to the average write bandwidth of the flash memory space. In this way, the bandwidth fluctuation of a host can be smoothed out. The present application can improve the consistency of the write performance of hosts, thereby improving the service quality of the flash memory device.

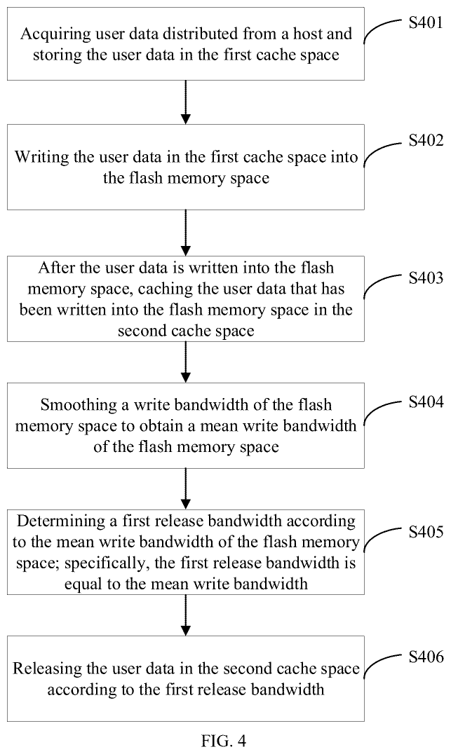

Specifically, referring to FIG. 4, FIG. 4 is a schematic flow chart of a data writing method according to embodiments of the present application.

The data writing method is applied to a flash memory device, specifically, to at least one processor of the flash memory device, and the subject executing the data writing method is at least one processor of the flash memory device.

As shown in FIG. 4, the data writing method includes the following steps S401 to S406:

Step S401: acquiring user data distributed from a host and storing the user data in the first cache space.

Specifically, the flash memory device acquires the user data distributed from a host. The flash memory device includes a high-speed cache space, and the high-speed cache space includes a first cache space. After the flash memory device receives the user data sent by the host, it caches the user data in the high-speed cache space. Specifically, the user data is cached in the first cache space of the high-speed cache space, and the first cache space is used to cache the user data distributed from a host.

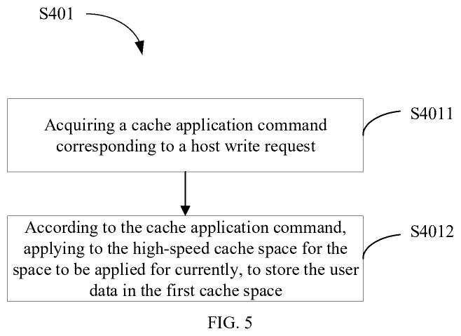

Further referring to FIG. 5, FIG. 5 is a schematic diagram of the detailed process of Step S401 in FIG. 4.

As shown in FIG. 5, the Step S401 of acquiring user data distributed from a host and storing the user data in the first cache space includes the following steps S4011 to S4012:

Step S4011: acquiring a cache application command corresponding to a host write request.

Specifically, the host sends a write request, and the write request corresponds to a cache application command, so that the flash memory device receives the cache application command. Specifically, the cache application command is used to apply to the high-speed cache space to cache the user data corresponding to the write request, and space related to the cache application command corresponds to the space to be applied for currently.

Step S4012: according to the cache application command, applying to the high-speed cache space for the space to be applied for currently, to store the user data in the first cache space.

Specifically, after the flash memory device receives the cache application command, it applies to the high-speed cache space for the space to be applied for currently corresponding to the cache application command, where the first cache space is computed by adding the first cache space that has been applied for and the space to be applied for currently.

Step S402: writing the user data in the first cache space into the flash memory space.

Specifically, after the flash memory device caches the user data distributed from the host in the first cache space, the user data in the first cache space is written into the flash memory space, that is to say, the user data in the first cache space is sent to the flash memory space, so that the flash memory space stores the user data.

Step S403: after the user data is written into the flash memory space, caching the user data that has been written into the flash memory space in the second cache space.

Specifically, the high-speed cache space further includes a first cache space. After the user data is copied from the first cache space to the flash memory space, the flash memory space needs to program the data to write it into the flash array of the flash memory space. After the user data is successfully written into the flash array of the flash memory space, the user data that has been written into the flash memory space is cached in a second cache space of the high-speed cache space. Specifically, the second cache space is used to cache the user data written into the flash memory space.

In embodiments of the present application, the flash programming completion status can be checked by means of the ready/busy pin of the NAND flash, or the status of the NAND flash can be viewed by means of the register, to determine whether the user data has been successfully written into the flash array of the flash memory space.

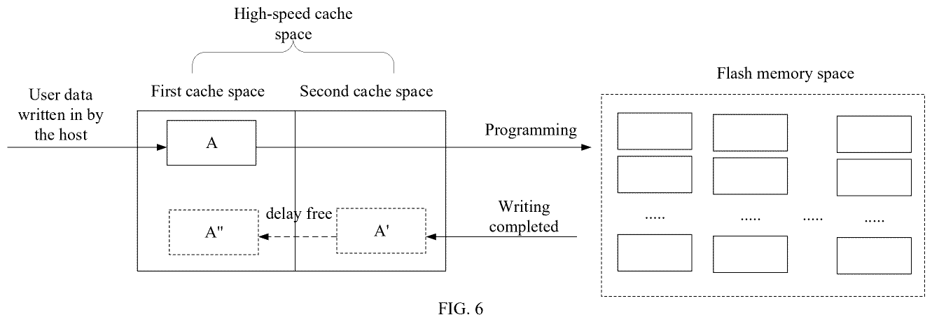

Referring to FIG. 6, FIG. 6 is a schematic diagram of another process of writing host data according to embodiments of the present application.

As shown in FIG. 6, the high-speed cache space includes a first cache space and a second cache space. Specifically, the first cache space is used to cache user data written in by a host, and the second cache space is used to cache user data written into the flash memory space. For example, after the user data A written in by the host is stored in the first cache space, the user data A in the first cache space is programmed to be written into the flash array of the flash memory space. After the user data A is successfully written into the flash array, the user data A′ in the second cache space is released from the second cache space, to replenish the released cache space to the first cache space.

Specifically, assuming that the first cache space is denoted as Cacheₜₒₜₐₗ, and the space applied for by the cache application command corresponding to the host write request is denoted as Cache_{alloc}, that is to say, the space applied for by the host is denoted as Cache_{alloc}, the space not applied for by the host is denoted as Cache_{free}, and the cache stored in the second cache space (denoted as Rsv cache) for which programming is done is denoted as Cacheᵣₛᵥ.

The change process of the cache space is described below, including the following steps (1) to (3):

(1) When a host write request occurs, the host applies for a cache to store user data. Assuming that the size of the user data is denoted as Sized_{data}, then Cache_{alloc} will make Size_{data} increase, and Cache_{free} will make Size_{data} decrease, where Cache_{alloc}+Cache_{free}=Cacheₜₒₜₐₗ.

(2) As the user data is continuously written in, Cache_{free} decreases to 0, and then no cache can be obtained for any new host write request. Meanwhile, as the writing speed of the flash is less than the writing speed of the cache, that is to say, the writing speed of the flash memory space is less than the writing speed of the high-speed cache space, the speed at which Cache_{free} increases is equal to the speed at which the host writes in.

(3) After the data corresponding to Size_{data} is successfully written into the flash memory space, that is to say, after programming is done, Cacheᵣₛᵥ makes Size_{data} increase, and Cache_{free} remains unchanged, so that the equation Cache_{alloc}+Cache_{free}=Cacheₜₒₜₐₗ still stands.

(4) According to the smoothed average bandwidth, the user data in the second cache space is released, to compensate the first cache space. For example, a cache space A′ in Cacheᵣₛᵥ is released to supplement Cache_{free}, so that Cacheᵣₛ, decreases, and Cache_{free} increases, thereby achieving releasing the cache space A′ from Cacheᵣₛᵥ to become a free buffer A″ in Cache_{free}.

Further, when Cache_{free} decreases to 0, it is necessary for the second cache space to release the user data to compensate the first cache space, so that the first cache space can continue to be used to meet the host's application for cache.

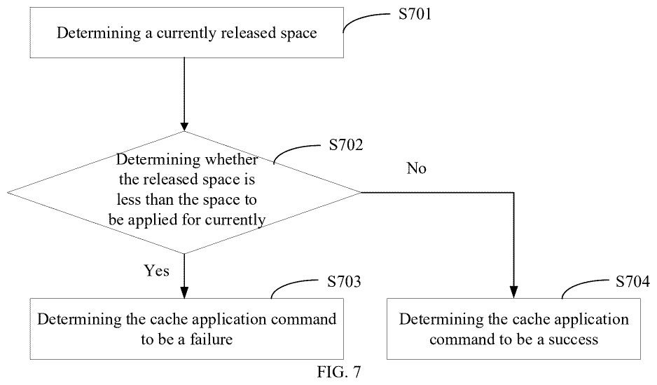

Specifically, further referring to FIG. 7, FIG. 7 is a schematic flow chart of a process of determining whether a cache application command corresponding to a host write request is successfully applied for according to embodiments of the present application.

As shown in FIG. 7, the process of determining whether a cache application command corresponding to a host write request is successfully applied for includes the following steps S701 to S703:

Step S701: determining a currently released space.

Specifically, after the user data in the second cache space is released, the currently released space is determined, and the currently released space is used to compensate the first cache space, so that the first cache space can continue to be used to meet the host's application for cache.

Step S702: determining whether the released space is less than the space to be applied for currently.

Going to Step S703 if the released space is less than the space to be applied for currently.

Going to Step S704 if the released space is greater than or equal to the space to be applied for currently.

Step S703: determining the cache application command to be a failure;

It can be understood that if the space to be applied for currently corresponding to the cache application command is greater than the released space of the second cache space, the free space in the first cache space cannot meet the cache application command, so that the cache application command is determined to be a failure.

Step S704: determining the cache application command to be a success.
if the released space is greater than or equal to the space to be applied for currently, determining the cache application command to be a success.

Step S404: smoothing a write bandwidth of the flash memory space to obtain an average write bandwidth of the flash memory space.

It can be understood that the write bandwidth of the flash memory space is a real-time variable, with different write bandwidths at different moments. Therefore, according to embodiments of the present application, the write bandwidth of the flash memory space is smoothed to obtain the average write bandwidth of the flash memory space, which is then used to characterize the write bandwidth of the flash memory space.

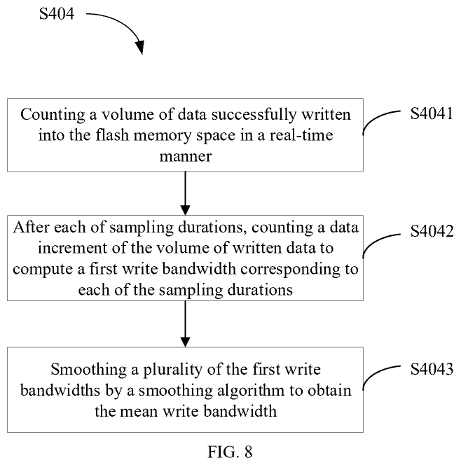

Further referring to FIG. 8, FIG. 8 is a schematic diagram of the detailed process of Step S404 in FIG. 4.

As shown in FIG. 8, the Step S404 of smoothing a write bandwidth of the flash memory space to obtain an average write bandwidth of the flash memory space includes the following steps S4041 to S4043:

Step S4041: counting a volume of data successfully written into the flash memory space in a real-time manner;

Specifically, the volume of data successfully written into the flash memory space is sampled, that is to say, the volume of data for which programming is done is sampled. It can be understood that as data continues to be written in, the volume of written data increases along with time.

Step S4042: after each of sampling durations, counting a data increment of the volume of written data to compute a first write bandwidth corresponding to each of the sampling durations;

Specifically, the first write bandwidth is computed by dividing the data increment by the sampling duration. For example, the counted volume of written data at a first moment is X₁, and the counted volume of written data after 100 ms is X₂. Accordingly, the data increment of the volume of written data in 100 ms is X₂-X₁. In this case, the first write bandwidth is (X₂−X₁)/100 ms.

For example, a most recent period of time T₁ includes a plurality of sampling durations, so that T₁ is the sampling cycle. Each of the sampling durations, for example, is 100 ms, so that the first write bandwidth is computed every 100 ms. Then, a plurality of first write bandwidths corresponding to the plurality of sampling durations are computed continuously in a one-on-one manner, thereby obtaining a plurality of write bandwidths.

Step S4043: smoothing a plurality of the first write bandwidths by a smoothing algorithm to obtain the average write bandwidth.

Specifically, a smoothing algorithm is used to smooth the plurality of first write bandwidths. The optional smoothing algorithms include moving average, median filtering, local weighted regression smoothing, Gaussian smoothing, weighted regression, box smoothing, and exponential smoothing. For example, the smoothing algorithm is the first-order lag filtering algorithm in exponential smoothing, where the equation of the first-order lag filtering algorithm is as follows:

$$B {W}_{avg} = B {W}_{avg} * ( 1 - a ) + B W * a$$

where BW_{avg} is the average write bandwidth, a is a coefficient, and BW is the first write bandwidth.

Alternatively, a circular queue is used to record bandwidth data for a last period of time, namely a plurality of first write bandwidths in the last period of time, and the average of the plurality of first write bandwidths is taken as an average write bandwidth.

It can be understood that when a smaller value is taken for a, the smoothing effect will be better, and the sampling cycle will be longer, while the change of the average first write bandwidth BW will respond more slowly to the fluctuation of BW. For example, when it takes 10 s to fill up a block with written data and the sampling cycle is 100 ms, a can be 1/64.

In embodiments of the present application, the historical bandwidths are sampled, and a smoothing algorithm is used to smooth the plurality of historical bandwidths, to better determine the release bandwidth of the high-speed cache space.

Step S405: determining a first release bandwidth according to the average write bandwidth of the flash memory space.

Specifically, the first release bandwidth is equal to the average write bandwidth BW_{avg}, that is to say, the average write bandwidth of the flash memory space is taken as the first release bandwidth, and the first release bandwidth is used to characterize the release speed of the user data in the second cache space.

Step S406: releasing the user data in the second cache space according to the first release bandwidth.

Specifically, the user data in the second cache space is released according to the first release bandwidth.

In embodiments of the present application, a second cache space is set in the high-speed cache space to cache user data that has been written into the flash memory space, and an average write bandwidth of the flash memory space is used to determine a release bandwidth of the second cache space, so that the second cache space releases the user data according to the average write bandwidth of the flash memory space. In this way, the bandwidth fluctuation of a host can be smoothed out. The present application can improve the consistency of the write performance of hosts, thereby improving the quality of service of the flash memory device.

It can be understood that a smoothing algorithm is used to sample the bandwidth BW_{Flash} of the flash and compute the average write bandwidth BW_{avg}, which is then taken as the release bandwidth to release the second cache space, so that the write bandwidth BWₕₒₛₜ of the host is equal to BW_{avg}.

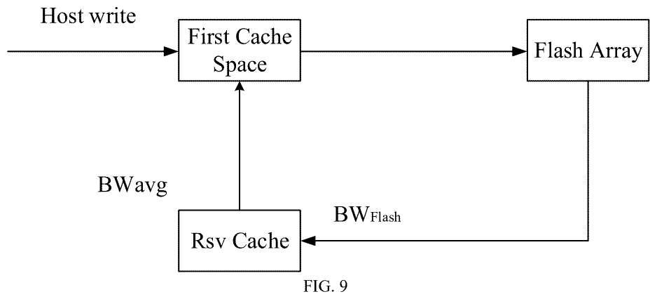

Referring to FIG. 9, FIG. 9 is a schematic diagram of a process of releasing the cache space according to embodiments of the present application.

As shown in FIG. 9, a host writes user data into a first cache space (denoted as cache), writes user data in the first cache space (cache) to a flash array, samples the bandwidth BW_{Flash} of the flash memory space (flash array) in a real-time manner, computes the average write bandwidth BW_{avg}, releases a second cache space (Rsv cache) according to the average write bandwidth BW_{avg}, and takes the released space to compensate the first cache space (cache).

However, when the bandwidth BW_{Flash} of the flash is sampled, sampling errors may occur, resulting in the overall performance being lower than the actual performance of the flash memory space. Based on this, the present application further proposes a feedback mechanism to adjust the release bandwidth.

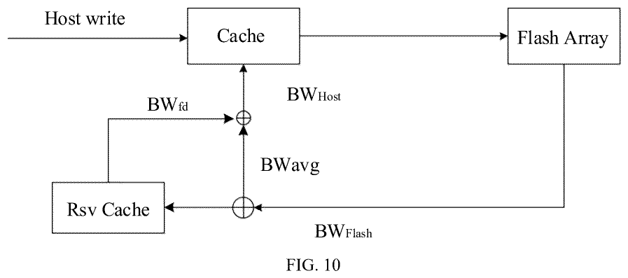

Specifically, further referring to FIG. 10, FIG. 10 is a schematic diagram of a bandwidth feedback mechanism according to embodiments of the present application.

As shown in FIG. 10, after the bandwidth BW_{Flash} of the flash memory space (flash array) is sampled in a real-time manner and the average write bandwidth BW_{avg} is obtained by computing, the feedback bandwidth (BW_{fd}) is used to compensate the average write bandwidth to obtain the adjusted first release bandwidth, so that the write bandwidth of the host (BWₕₒₛₜ) is equal to the adjusted first release bandwidth.

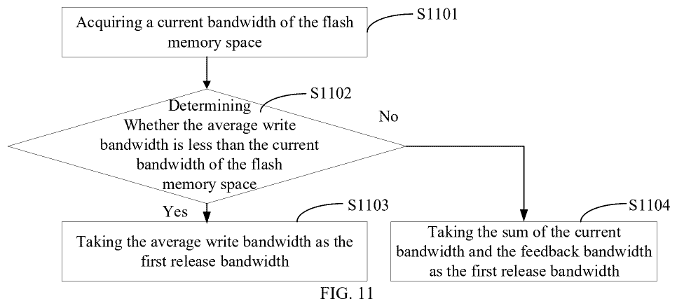

Specifically, further referring to FIG. 11, FIG. 11 is a schematic flow chart of a process of determining a first release bandwidth according to embodiments of the present application.

As shown in FIG. 11, the process of determining a first release bandwidth includes the following steps S1101 to S1104:

Step S1101: acquiring a current bandwidth of the flash memory space;

Specifically, the current bandwidth of the flash memory space is the current write bandwidth of the flash memory space. The data increment of the volume of written data in the sampling duration counted in a real-time manner is used to compute the current bandwidth BW_{Flash} of the flash memory space in the sampling duration, where the current bandwidth BW_{Flash} is computed by dividing the data increment of the volume of written data in the sampling duration by the sampling duration.

Step S1102: determining whether the average write bandwidth is less than the current bandwidth of the flash memory space.

Specifically, determining whether the average write bandwidth BW_{avg} is less than the current bandwidth BW_{Flash} of the flash memory space. If yes, going to Step S1103. If not, going to Step S1104.

It can be understood that if the average write bandwidth BW_{avg} is greater than or equal to the current bandwidth BW_{Flash} of the flash memory space, the average write bandwidth BW_{avg} will converge to BW_{Flash} by means of a smoothing algorithm.

If the average write bandwidth BW_{avg} is less than the current bandwidth BW_{Flash}, since the second cache space takes the average write bandwidth as the release bandwidth, the volume of written data will be greater than the volume of data released, and the user data space in the second cache space will be greater than the release space used to compensate the first cache space, so that a part of the user data space (the cache for which programming is done) will still be in the second cache space. That is to say, the cache for which programming is done, which is the difference of BW_{Flash} minus BW_{avg}, will be first accumulated in the second cache space (Rsv cache), and the volume of data accumulated will increase along with time.

In view of this, under the condition that the average write bandwidth BW_{avg} is greater than the current bandwidth BW_{Flash}, the present application further adds a feedback bandwidth (BW_{fd}) to the current bandwidth BW_{Flash} to compensate the current bandwidth BW_{Flash}, and takes the compensated bandwidth as the first release bandwidth.

Step S1103: taking the average write bandwidth as the first release bandwidth.

It can be understood that when the average write bandwidth BW_{avg} is less than the current bandwidth BW_{Flash}, the average write bandwidth is directly taken as the first release bandwidth to release the user data in the second cache space according to the first release bandwidth.

Step S1104: taking the sum of the current bandwidth and the feedback bandwidth as the first release bandwidth.

Specifically, if the average write bandwidth BW_{avg} is greater than or equal to the current bandwidth BW_{Flash}, the sum of the current bandwidth and the feedback bandwidth is taken as the first release bandwidth, that is to say, the first release bandwidth is computed by adding the current bandwidth BW_{Flash} and the feedback bandwidth BW_{fd}, to release the user data in the second cache space by means of the updated first release bandwidth.

In embodiments of the present application, the feedback bandwidth is computed by multiplying a first coefficient and a user data space, and the user data space is the size of the user data in a second cache space.

Specifically, the user data space is the user data in the second cache space that has been successfully written into the flash memory space, namely the user data accumulated in the Rsv cache, for which programming is done. The first coefficient can be set according to actual needs, or calibrated based on experimental results.

In embodiments of the present application, a feedback mechanism is used, that is to say, a feedback bandwidth is used to compensate the current bandwidth under the condition that the average write bandwidth is greater than or equal to the current bandwidth of the flash memory space, which can better solve the performance problems caused by sampling errors, and correct smaller performance evaluation errors, to better improve the consistency of the write performance of the host, thereby improving the quality of service of the flash memory device.

Further, based on the feedback mechanism, embodiments of the present application provide a water line mechanism.

It can be understood that since the user data in the second cache space will be released, the size of the user data in the second cache space is dynamically changing, that is to say, the user data space is dynamically changing, and the user data space is the size of the data successfully written into the flash memory space, namely the cache stored in the second cache space (Rsv cache) for which programming is done, which is denoted as Cacheᵣₛᵥ.

In embodiments of the present application, the feedback bandwidth is determined by the relationship of size between the user data space Cacheᵣₛᵥ and the water line.

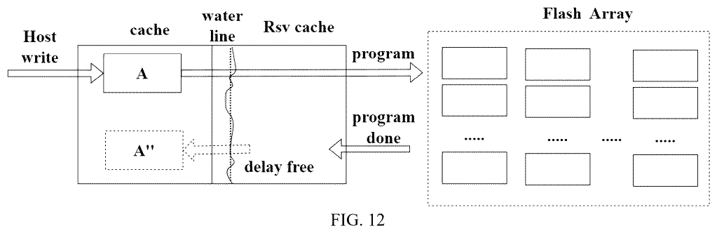

Further referring to FIG. 12, FIG. 12 is a schematic diagram of a water line according to embodiments of the present application.

As shown in FIG. 12, the water line is less than the size of the second cache space (Rsv cache).

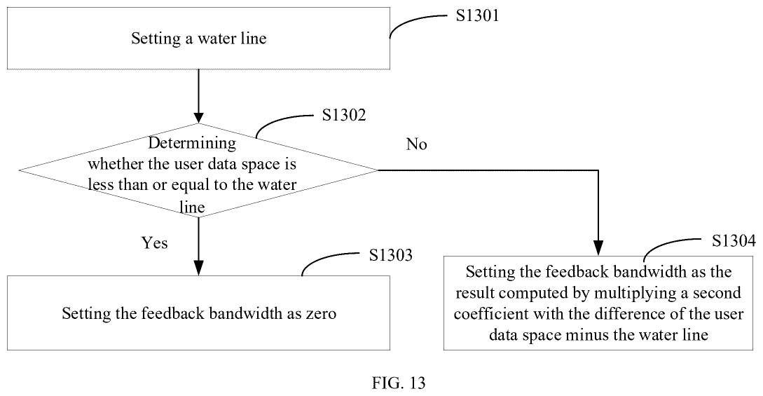

Specifically, further referring to FIG. 13, FIG. 13 is a schematic flow chart of a process of determining a feedback bandwidth according to embodiments of the present application.

As shown in FIG. 13, the process of determining a feedback bandwidth includes the following steps S1301 to S1304:

Step S1301: setting a water line.

In this step, Cache_{waterLine} is less than the size of the second cache space.

Step S1302: determining whether the user data space is less than or equal to the water line.

Specifically, determining whether the user data space is less than or equal to the water line. If yes, going to Step S1303. If not, going to Step S1304.

Step S1303: setting the feedback bandwidth as zero.

Specifically, if the user data space is less than or equal to the water line, the feedback bandwidth is set as zero.

Step S1304: setting the feedback bandwidth as the result computed by multiplying a second coefficient with the difference of the user data space minus the water line.

Specifically, if the user data space is greater than the water line, the feedback bandwidth is set as the result computed by multiplying a second coefficient with the difference of the user data space minus the water line.

In embodiments of the present application, the feedback bandwidth BW_{fd}=b*max(0, Cacheᵣₛᵥ−Cache_{waterLine}), where b is a second coefficient, and max(0, Cacheᵣₛᵥ−Cache_{waterLine}) refers to the greater one of 0 or (Cacheᵣₛᵥ−Cache_{waterLine}). For example:

If the difference between the user data space and the water line is greater than 0, that is to say, Cacheᵣₛᵥ−Cache_{waterLine}>0, the feedback bandwidth=b*(Cacheᵣₛᵥ−Cache_{waterLine}).

If the difference between the user data space and the water line is less than or equal to 0, that is to say, Cacheᵣₛᵥ−Cache_{waterLine}≤0, the feedback bandwidth=b*0=0.

In embodiments of the present application, the second coefficient may be equal to or different from the first coefficient. The second coefficient can be set according to actual needs, or calibrated based on experimental results.

It can be understood that when there is no water line Cache_{waterLine}, Cacheᵣₛᵥ is based on 0, that is to say, BW_{fd}=a*Cacheᵣₛᵥ. When Cacheᵣₛᵥ is 0, no feedback compensation is required. When performance drops, the cache for compensation is limited. In embodiments of the present application, a water line Cache_{waterLine} is set, so that BW_{fd}=b*max(0, Cacheᵣₛᵥ−Cache_{waterLine}). When the current bandwidth is less than the average bandwidth, Cacheᵣₛᵥ will have more caches for compensation.

For example, as shown in FIG. 12, Cache_{waterLine} is taken as 10 MB. If the current bandwidth is greater than the average bandwidth, when Cacheᵣₛᵥ is less than 10 MB, which means that the user data space does not exceed the dotted line, no feedback compensation is required, and the data will be accumulated in Cacheᵣₛᵥ. When Cacheᵣₛᵥ is greater than 10 MB, which means that the user data space exceeds the dotted line, feedback compensation is performed to increase the release speed of Cacheᵣₛᵥ.

It can be understood that a larger water line Cache_{waterLine} is better, so that it can compensate for more performance drops. However, cache is also constrained by cost, and the water line needs to be determined by balancing the cost and smoothing effect in actual use.

In embodiments of the present application, a waterline mechanism is used to achieve no feedback compensation when Cacheᵣₛᵥ is less than Cache_{waterLine}, so that more caches are accumulated in the second cache space (Rsv cache), which can better compensate when the performance is lower than BW_{avg}.

It can be understood that before the current bandwidth of the flash memory space is sampled, it is temporarily impossible to smooth the write bandwidth of the flash memory space due to the lack of an evaluation of the write bandwidth of the flash memory space. However, in the application scenario with a flash memory device, the write bandwidth of the host might be less than the bandwidth capacity of the flash memory device. For example, the write bandwidth capacity of SSD is 2 GB/s, but the write bandwidth of the host is only 300 MB/s, so smoothing is not required.

Therefore, in embodiments of the present application, the smooth state of the flash memory device is further determined according to the current situation of the flash memory device and the host, to adapt to different application scenarios, so that for different IO models, a fast response can be achieved to complete sampling (ramp up).

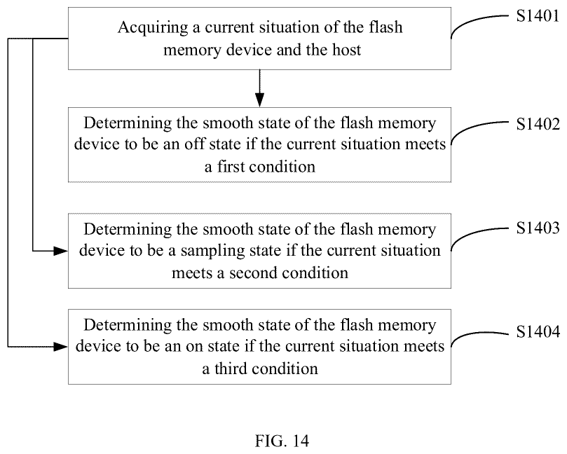

Specifically, referring to FIG. 14, FIG. 14 is a schematic flow chart of a process of determining the smooth state of a flash memory device according to embodiments of the present application.

As shown in FIG. 14, determining the smooth state of the flash memory device includes the following steps S1401 to S1404:

Step S1401: acquiring a current situation of the flash memory device and the host.

Specifically, the smooth states of the flash memory device include an off state, a sampling state, and an on state.

Step S1402: determining the smooth state of the flash memory device to be an off state if the current situation meets a first condition.

It can be understood that no smoothing is required if the smooth state of the flash memory device is an off state (State_{off}).

Specifically, the first condition is that the write bandwidth of the host is zero, or when the host applies to the high-speed cache space for a cache space, the number of successes is greater than the number of failures or the write bandwidth of the host is less than the target bandwidth of the flash memory device.

For this purpose, the first condition includes three cases as follows, and the current situation meets the first condition when at least one of the following three cases is achieved:

(1) The write bandwidth of the host is zero.

Specifically, the write bandwidth of the host is zero, which means that the host is not sending any write requests to the flash memory device, so that the host does not need to write user data into the flash memory device. Then, the write bandwidth of the host is zero, that is to say, the host write request is 0.

(2) When the host applies to the high-speed cache space for a cache space, the number of successes is greater than the number of failures.

Specifically, when the host sends a cache application command to the flash memory device, the numbers of successes and failures are counted. If the number of successes is greater than the number of failures, the current situation meets the first condition.

Further, if the number of successes is much greater than the number of failures, the current situation meets the first condition. For example, a first ratio of the number of successes to the number of failures is computed, where the first ratio is computed by dividing the number of successes by the number of failures. If the first ratio is greater than a preset coefficient, it is determined that the current situation meets the first condition. In embodiments of the present application, the preset coefficient can be set according to actual needs, or calibrated according to experimental results. For example, the preset coefficient is set as 100.

(3) The write bandwidth of the host is less than the target bandwidth of the flash memory device.

Specifically, the target bandwidth of a flash memory device refers to the maximum bandwidth of the flash memory device. If the write bandwidth of the host is less than the target bandwidth of the flash memory device, the write speed of the host cannot keep up with the write speed of the flash memory space. Then, it is unnecessary to smooth the write bandwidth of the flash memory device.

Step S1403: determining the smooth state of the flash memory device to be a sampling state if the current situation meets a second condition.

It can be understood that if the smooth state of the flash memory device is a sampling state (Stateᵣₐₘₚ), the bandwidth is not limited, and then the write bandwidth of the flash memory space needs to be sampled.

Specifically, the second condition is that the write bandwidth of the host is not zero, and when the host applies to the high-speed cache space for a cache space, the number of successes is less than the number of failures or the write bandwidth of the host is greater than the target bandwidth of the flash memory device.

For this purpose, the first condition includes three cases as follows, and the current situation meets the first condition when all the following three situations are achieved at the same time:

(1) The write bandwidth of the host is not zero.

Specifically, the write bandwidth of the host is not zero, which means that the host sends a write request to the flash memory device, so that the host needs to write user data into the flash memory device. Then, the write bandwidth of the host is not zero, that is to say, the host write request is not 0.

(2) When the host applies to the high-speed cache space for a cache space, the number of successes is less than the number of failures.

Specifically, when the host sends a cache application command to the flash memory device, the numbers of successes and failures are counted. If the number of successes is less than the number of failures, case (2) is achieved.

Further, if the first ratio of the number of successes to the number of failures is less than a preset coefficient, case (2) is achieved. For this purpose, the first ratio is computed by dividing the number of successes by the number of failures. In embodiments of the present application, the preset coefficient can be set according to actual needs, or calibrated according to experimental results. For example, the preset coefficient is set as 100.

(3) The write bandwidth of the host is greater than the target bandwidth of the flash memory device.

Specifically, the target bandwidth of a flash memory device refers to the maximum bandwidth of the flash memory device. If the write bandwidth of the host is greater than the target bandwidth of the flash memory device, the write speed of the host is greater than the write speed of the flash memory space. Then, it is necessary to smooth the write bandwidth of the flash memory device.

Step S1404: determining the smooth state of the flash memory device to be an on state if the current situation meets a third condition.

It can be understood that if the smooth state of the flash memory device is the on state (Stateₒₙ), it is necessary to smooth the write bandwidth of the flash memory device.

Specifically, the third condition includes the case that the sampling duration of the sampling state is greater than a preset time threshold. For this purpose, the preset time threshold can be set according to specific needs, for example, 10 s. After the sampling duration is greater than 10 s, the write bandwidth of the flash memory space is smoothed to obtain the average write bandwidth of the flash memory space.

It can be understood that when the current condition of the flash memory device and the host changes, it is necessary to switch the smooth state of the flash memory device.

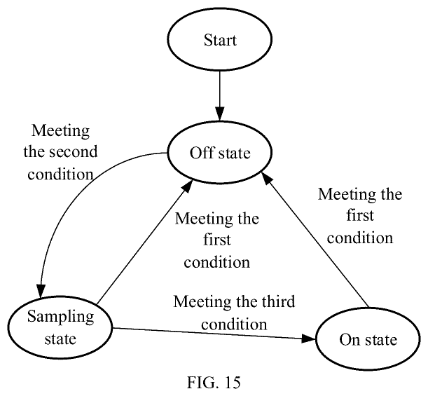

Specifically, further referring to FIG. 15, FIG. 15 is a schematic diagram of a process of switching smooth states according to embodiments of the present application.

As shown in FIG. 15, switching the smooth state of the flash memory device includes:
when the smooth state of the flash memory device is the off state, switching the smooth state of the flash memory device to the sampling state if the current situation meets the second condition;
when the smooth state of the flash memory device is the sampling state, switching the smooth state of the flash memory device to the off state if the current situation meets the first condition, or switching the smooth state of the flash memory device to the on state if the current situation meets the third condition; and
when the smooth state of the flash memory device is the on state, switching the system state of the flash memory device to the off state if the current situation meets the first condition.

It should be noted that the first condition, the second condition, and the third condition can refer to the above description and will not be repeated here.

In embodiments of the present application, switching the smooth state of the flash memory device further includes:
when the smooth state of the flash memory device is the on state,
computing a first average write bandwidth of the flash memory space in a first sampling cycle;
computing a second average write bandwidth of the flash memory space in a second sampling cycle; specifically, the second sampling cycle is longer than the first sampling cycle; and
if the difference between the first average write bandwidth and the second average write bandwidth is greater than a difference threshold, switching from the on state to the off state.

It can be understood that the first sampling cycle is a short cycle, and the second sampling cycle is a long cycle. Sampling in the long cycle results in the average bandwidth for a long time, and sampling in the short cycle results in the average bandwidth for a short time. When the long cycle and short cycle are not equal, the flash memory device is not in a stable bandwidth state. Then it is necessary to switch from the on state to the off state to re-adjust the flash memory device to a stable bandwidth state and achieve bandwidth balance.

Specifically, assuming that the first sampling cycle is T₁ and the second sampling cycle is T₂, where T₂>T₁, each sampling duration in the first sampling cycle T₁ is sampled to obtain a plurality of first write bandwidths, and the plurality of first write bandwidths are smoothed by a smoothing algorithm to obtain the first average write bandwidth corresponding to the first sampling cycle. Similarly, each sampling duration in the second sampling cycle T₂ is sampled to obtain a plurality of first write bandwidths, and the plurality of first write bandwidths are smoothed by a smoothing algorithm to obtain a second average write bandwidth corresponding to the second sampling cycle.

If the difference between the first average write bandwidth and the second average write bandwidth is greater than a difference threshold, switch from the on state to the off state (State_{off}).

In embodiments of the present application, the first sampling cycle T₁ and the second sampling cycle T₂ can be set according to specific needs. For example, the first sampling cycle is set as T₁=5 s, and the second sampling cycle is set as T₂=8 s.

In embodiments of the present application, the difference threshold can be set according to specific needs. For example, the difference threshold is set as the larger value of the preset bandwidth threshold and (Average write bandwidth*Third coefficient), namely Difference threshold=max(Preset bandwidth threshold, Average write bandwidth*Third coefficient). For example, if the preset bandwidth threshold is 50 MB/s and the third coefficient is 0.1, then Difference threshold=max(50 MB/s, BW_{avg}*0.1).

In embodiments of the present application, the state can be managed better by determining the smooth state of the flash memory device and switching the smooth state of the flash memory device in a real-time manner according to the current situation, thereby quickly responding to changes in the IO model, and improving the stability of the flash memory device.

In embodiments of the present application, a data writing method is provided and applied to a flash memory device; the flash memory device includes a high-speed cache space and a flash memory space; the high-speed cache space includes a first cache space and a second cache space; specifically, the first cache space is used to cache user data sent by a host, and the second cache space is used to cache user data written into the flash memory space. The method includes: acquiring user data distributed from a host and storing the user data in the first cache space; writing the user data in the first cache space into the flash memory space; after the user data is written into the flash memory space, caching the user data that has been written into the flash memory space in the second cache space; smoothing a write bandwidth of the flash memory space to obtain an average write bandwidth of the flash memory space; determining a first release bandwidth according to the average write bandwidth of the flash memory space, where the first release bandwidth is equal to the average write bandwidth; and releasing the user data in the second cache space according to the first release bandwidth.

According to the data writing method, a second cache space is set in the high-speed cache space to cache user data that has been written into the flash memory space, and an average write bandwidth of the flash memory space is used to determine a release bandwidth of the second cache space, so that the second cache space releases the user data according to the average write bandwidth of the flash memory space. In this way, the bandwidth fluctuation of a host can be smoothed out. The present application can improve the consistency of the write performance of hosts, thereby improving the service quality of the flash memory device.

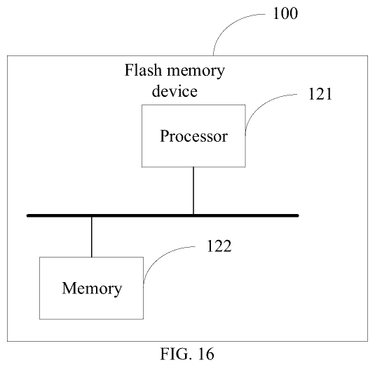

Further referring to FIG. 16, FIG. 16 is a schematic diagram illustrating the structure of another flash memory device according to embodiments of the present application.

As shown in FIG. 16, the flash memory device 100 includes one or more processors 121 and memories 122. FIG. 16 shows an example when one processor 121 is used.

The processors 121 and the memories 122 can be connected through a bus or by other means, and FIG. 16 shows an example of connecting through a bus.

The processors 121 are used to provide computing and control capabilities to control the flash memory device 100 to perform corresponding tasks, for example, to control the flash memory device 100 to perform a data writing method in any of the embodiment methods described above. This data writing method is applied to the flash memory device; the flash memory device includes a high-speed cache space and a flash memory space; the high-speed cache space includes a first cache space and a second cache space; specifically, the first cache space is used to cache user data sent by a host, and the second cache space is used to cache user data written into the flash memory space. The method includes: acquiring user data distributed from a host and storing the user data in the first cache space; writing the user data in the first cache space into the flash memory space; after the user data is written into the flash memory space, caching the user data that has been written into the flash memory space in the second cache space; smoothing a write bandwidth of the flash memory space to obtain an average write bandwidth of the flash memory space; determining a first release bandwidth according to the average write bandwidth of the flash memory space, where the first release bandwidth is equal to the average write bandwidth; and releasing the user data in the second cache space according to the first release bandwidth.

According to the data writing method, a second cache space is set in the high-speed cache space to cache user data that has been written into the flash memory space, and an average write bandwidth of the flash memory space is used to determine a release bandwidth of the second cache space, so that the second cache space releases the user data according to the average write bandwidth of the flash memory space. In this way, the bandwidth fluctuation of a host can be smoothed out. The present application can improve the consistency of the write performance of hosts, thereby improving the service quality of the flash memory device.

The processors 121 can be general-purpose processors, such as central processing units (CPUs), network processors (NPs), hardware chips, or any combination thereof. They can alternatively be digital signal processors (DSPs), application specific integrated circuits (ASICs), programmable logic devices (PLDs), or any combination thereof. The above-mentioned PLDs can be complex programmable logic devices (CPLDs), field-programmable gate arrays (FPGAs), generic array logics (GALs), or any combination thereof.

As non-transitory computer-readable storage media, the memories 122 can be used to store non-transitory software programs, non-transitory computer-executable programs, and modules, such as program instructions/modules corresponding to the data writing method according to embodiments of the present application. The processors 121 can implement the data writing method in any of the following embodiment methods by running non-transitory software programs, instructions, and modules stored in the memories 122. Specifically, the memories 122 can include volatile memories (VMs), such as random access memories (RAMs). The memories 122 can alternatively include non-volatile memories (NVMs), such as read-only memories (ROMs), flash memories, hard disk drives (HDDs), solid-state drives (SSDs), or other non-transient solid-state storage devices. The memories 122 can also include a combination of the above-mentioned types of memories.

The memories 122 can include high-speed random access memories, alternatively non-volatile memories, such as at least one disk memory device, flash device, or any other non-volatile solid-state memory device. In some embodiments, the memories 122 can optionally include memories that are remotely arranged relative to the processors 121, and these remote memories can be connected to the processors 121 through a network. Examples of the above networks include but are not limited to the Internet, corporate intranets, local area networks, mobile communication networks, and combinations thereof.

One or more modules are stored in each of the memories 122, and when executed by one or more processors 121, the data writing method in any of the above-mentioned embodiment methods is performed, such as in the steps as shown in FIG. 3 described above.

In embodiments of the present application, the flash memory device 100 may further have components such as a wired or wireless network interface, a keyboard, and an input/output interface for input and output. The flash memory device 100 may further include other components for realizing the functions of the device, which will not be described in detail here.

Embodiments of the present application also provide a computer-readable storage medium, such as a memory including program code, which can be executed to implement the data writing method in the above embodiments by a processor. For example, the computer-readable storage medium can be a Read-Only Memory (ROM), a Random Access Memory (RAM), a Compact Disc Read-Only Memory (CDROM), a magnetic tape, a floppy disk, an optical data storage device, etc.

The embodiments of the present application also provide a computer program product, which includes one or more program codes stored in a computer-readable storage medium. The processor of the flash device reads the program code from the computer-readable storage medium, and the processor executes the program code to complete the method steps of the data writing method provided in the above embodiments.

Those of ordinary skill in the art can understand that all or part of the steps for implementing the above-described embodiments can be accomplished by hardware, or by hardware associated with program code through a program, which can be stored in a computer-readable storage medium. The storage medium mentioned above can be a read-only memory, a disk, an optical disc, or the like.

Through the description of the above implementation modes, those of ordinary skill in the art can clearly understand that each implementation mode can be implemented by means of software plus a general hardware platform, and of course, it can also be implemented by hardware. Those of ordinary skill in the art can understand that all or part of the processes in the methods of the above embodiments can be completed by instructing relevant hardware through a computer program, which can be stored in a computer-readable storage medium. When the program is executed, it may include the processes of the embodiments of the above methods. Among them, the storage medium may be a magnetic disk, an optical disk, a read-only memory (ROM), a random access memory (RAM), etc.

Finally, it should be noted that: the above embodiments are merely used to illustrate the technical solutions of the present application, rather than to limit them; under the concept of the present application, the technical features in the above embodiments or different embodiments may also be combined, the steps may be implemented in any order, and there are many other variations in different aspects of the present application as described above, which are not provided in detail for the sake of brevity; although the present application has been described in detail with reference to the foregoing embodiments, those of ordinary skill in the art should understand that: they may still modify the technical solutions described in the foregoing embodiments, or equivalently replace some of the technical features therein; and these modifications or replacements do not cause the essence of the corresponding technical solutions to deviate from the scope of the technical solutions of the various embodiments of the present application.

What is claimed is:

1. A data writing method applied to a flash memory device, wherein the flash memory device comprises a high-speed cache space and a flash memory space, and the high-speed cache space comprises a first cache space and a second cache space, wherein the first cache space is used to cache user data sent by a host, and the second cache space is used to cache user data written into the flash memory space, and wherein the method comprises:
acquiring user data distributed from the host and storing the user data in the first cache space;
writing the user data in the first cache space into the flash memory space;
caching the user data in the second cache space after the user data is written into the flash memory space;
smoothing a write bandwidth of the flash memory space to obtain an average write bandwidth of the flash memory space;
determining a first release bandwidth according to the average write bandwidth of the flash memory space, wherein the first release bandwidth is equal to the average write bandwidth; and
releasing the user data in the second cache space according to the first release bandwidth.

2. The method according to claim 1, wherein smoothing the write bandwidth of the flash memory space to obtain the average write bandwidth of the flash memory space comprises:
counting a volume of data that is successfully written into the flash memory space in a real-time manner;
determining a plurality of first write bandwidths corresponding to a plurality of sampling durations at least by:
after each sampling duration, counting a data increment of the volume of written data to compute a first write bandwidth corresponding to the sampling duration, wherein the first write bandwidth is computed by dividing the data increment by the sampling duration; and
smoothing the plurality of first write bandwidths by a smoothing algorithm to obtain the average write bandwidth.

3. The method according to claim 2, further comprising:
acquiring a current bandwidth of the flash memory space;
determining whether the average write bandwidth is less than the current bandwidth of the flash memory space;
determining the first release bandwidth to be the average write bandwidth responsive to the average write bandwidth being less than the current bandwidth; and
determining the first release bandwidth to be a sum of the current bandwidth and a feedback bandwidth responsive to the average write bandwidth being greater than or equal to the current bandwidth, wherein the feedback bandwidth is computed by multiplying a first coefficient with a user data space, wherein the user data space is a size of user data in a second cache space.

4. The method according to claim 3, further comprising:
determining the feedback bandwidth according to the user data space, comprising:
setting a water line, wherein the water line is less than the second cache space;
determining whether the user data space is less than or equal to the water line;
responsive to the user data space being less than or equal to the water line, setting the feedback bandwidth as zero; and
responsive to the user data space being greater than the water line, setting the feedback bandwidth as a result computed by multiplying a second coefficient with a difference of the user data space minus the water line.

5. The method according to claim 1, wherein acquiring the user data distributed from the host and storing the user data in the first cache space comprises:
acquiring a cache application command corresponding to a host write request, wherein the cache application command corresponds to a currently-to-be-applied space; and
according to the cache application command, applying for the currently-to-be-applied space in the high-speed cache space to store the user data in the first cache space, wherein the first cache space is updated by adding the first cache space that has been applied for caching other user data sent by the host with the currently-to-be applied space.

6. The method according to claim 5, wherein after the user data in the second cache space is released, the method further comprises:
determining a currently released space, wherein the currently released space is used to compensate the first cache space;
when the currently released space is less than the currently-to-be-applied, determining that an execution of the cache application command fails; or
when the currently released space is greater than or equal to the currently-to-be-applied space, determining that the execution of the cache application command succeeds.

7. The method according to claim 1, further comprising:
determining a smooth state of the flash memory device according to a current situation of the flash memory device and the host, comprising:
determining the smooth state of the flash memory device to be an off state when the current situation meets a first condition, wherein the first condition is that a write bandwidth of the host is zero, or when the host applies to the high-speed cache space for a cache space, the number of successes is greater than a number of failures or the write bandwidth of the host is less than a target bandwidth of the flash memory device;
determining the smooth state of the flash memory device to be a sampling state when the current situation meets a second condition, wherein the second condition is that the write bandwidth of the host is not zero, and when the host applies to the high-speed cache space for a cache space, the number of successes is less than the number of failures or the write bandwidth of the host is greater than the target bandwidth of the flash memory device; and
determining the smooth state of the flash memory device to be an on state when the current situation meets a third condition, wherein the third condition is that a sampling duration of the sampling state is greater than a preset time threshold.

8. The method according to claim 7, further comprising:
switching the smooth state of the flash memory device, comprising:
when the smooth state of the flash memory device is the off state, switching the smooth state of the flash memory device to the sampling state when the current situation meets the second condition;
when the smooth state of the flash memory device is the sampling state, switching the smooth state of the flash memory device to the off state when the current situation meets the first condition, or switching the smooth state of the flash memory device to the on state when the current situation meets the third condition; and
when the smooth state of the flash memory device is the on state, switching the smooth state of the flash memory device to the off state when the current situation meets the first condition.

9. The method according to claim 8, wherein switching the smooth state of the flash memory device further comprises:
when the smooth state of the flash memory device is the on state,
computing a first average write bandwidth of the flash memory space in a first sampling cycle; and
computing a second average write bandwidth of the flash memory space in a second sampling cycle, wherein the second sampling cycle is longer than the first sampling cycle; and
when the difference between the first average write bandwidth and the second average write bandwidth is greater than a difference threshold, switching from the on state to the off state.

10. A flash memory device, comprising:
a flash memory space;
a high-speed cache space comprising a first cache space and a second cache space, wherein the first cache space is used to cache user data sent by a host, and the second cache space is used to cache user data written into the flash memory space;
a processor; and
a memory storing instructions that, when executed by the processor, cause the processor to perform operations comprising:
acquiring user data distributed from the host and storing the user data in the first cache space;
writing the user data in the first cache space into the flash memory space;
caching the user data in the second cache space after the user data is written into the flash memory space;
smoothing a write bandwidth of the flash memory space to obtain an average write bandwidth of the flash memory space;
determining a first release bandwidth according to the average write bandwidth of the flash memory space, wherein the first release bandwidth is equal to the average write bandwidth; and
releasing the user data in the second cache space according to the first release bandwidth.

11. The flash memory device according to claim 10, wherein smoothing the write bandwidth of the flash memory space to obtain the average write bandwidth of the flash memory space comprises:
counting a volume of data that is successfully written into the flash memory space in a real-time manner;
determining a plurality of first write bandwidths corresponding to a plurality of sampling durations at least by:
after each sampling duration, counting a data increment of the volume of written data to compute a first write bandwidth corresponding to the sampling duration, wherein the first write bandwidth is computed by dividing the data increment by the sampling duration; and
smoothing the plurality of first write bandwidths by a smoothing algorithm to obtain the average write bandwidth.

12. The flash memory device according to claim 11, wherein the operations further comprise:
acquiring a current bandwidth of the flash memory space;
determining whether the average write bandwidth is less than the current bandwidth of the flash memory space;
determining the first release bandwidth to be the average write bandwidth responsive to the average write bandwidth being less than the current bandwidth; and
determining the first release bandwidth to be a sum of the current bandwidth and a feedback bandwidth responsive to the average write bandwidth being greater than or equal to the current bandwidth, wherein the feedback bandwidth is computed by multiplying a first coefficient with a user data space, wherein the user data space is a size of user data in a second cache space.

13. The flash memory device according to claim 12, wherein the operations further comprise:
determining the feedback bandwidth according to the user data space, comprising:
setting a water line, wherein the water line is less than the second cache space;
determining whether the user data space is less than or equal to the water line;
responsive to the user data space being less than or equal to the water line, setting the feedback bandwidth as zero; and
responsive to the user data space being greater than the water line, setting the feedback bandwidth as a result computed by multiplying a second coefficient with a difference of the user data space minus the water line.

14. The flash memory device according to claim 10, wherein acquiring the user data distributed from the host and storing the user data in the first cache space comprises:
acquiring a cache application command corresponding to a host write request, wherein the cache application command corresponds to a currently-to-be-applied space; and
according to the cache application command, applying for the currently-to-be-applied space in the high-speed cache space to store the user data in the first cache space, wherein the first cache space is updated by adding the first cache space that has been applied for caching other user data sent by the host with the currently-to-be applied space.

15. The flash memory device according to claim 14, wherein after the user data in the second cache space is released, the operations further comprise:
determining a currently released space, wherein the currently released space is used to compensate the first cache space;
when the currently released space is less than the currently-to-be-applied, determining that an execution of the cache application command fails; or
when the currently released space is greater than or equal to the currently-to-be-applied space, determining that the execution of the cache application command succeeds.

16. The flash memory device according to claim 10, wherein the operations further comprise:
determining a smooth state of the flash memory device according to a current situation of the flash memory device and the host, comprising:
determining the smooth state of the flash memory device to be an off state when the current situation meets a first condition, wherein the first condition is that a write bandwidth of the host is zero, or when the host applies to the high-speed cache space for a cache space, the number of successes is greater than a number of failures or the write bandwidth of the host is less than a target bandwidth of the flash memory device;
determining the smooth state of the flash memory device to be a sampling state when the current situation meets a second condition, wherein the second condition is that the write bandwidth of the host is not zero, and when the host applies to the high-speed cache space for a cache space, the number of successes is less than the number of failures or the write bandwidth of the host is greater than the target bandwidth of the flash memory device; and
determining the smooth state of the flash memory device to be an on state when the current situation meets a third condition, wherein the third condition is that a sampling duration of the sampling state is greater than a preset time threshold.

17. The flash memory device according to claim 16, wherein the operations further comprise:
switching the smooth state of the flash memory device, comprising:
when the smooth state of the flash memory device is the off state, switching the smooth state of the flash memory device to the sampling state when the current situation meets the second condition;
when the smooth state of the flash memory device is the sampling state, switching the smooth state of the flash memory device to the off state when the current situation meets the first condition, or switching the smooth state of the flash memory device to the on state when the current situation meets the third condition; and
when the smooth state of the flash memory device is the on state, switching the smooth state of the flash memory device to the off state when the current situation meets the first condition.

18. The flash memory device according to claim 17, wherein switching the smooth state of the flash memory device further comprises:
when the smooth state of the flash memory device is the on state,
computing a first average write bandwidth of the flash memory space in a first sampling cycle; and
computing a second average write bandwidth of the flash memory space in a second sampling cycle, wherein the second sampling cycle is longer than the first sampling cycle; and
when the difference between the first average write bandwidth and the second average write bandwidth is greater than a difference threshold, switching from the on state to the off state.

19. A non-transitory computer-readable storage medium storing instructions that, when executed by a processor, cause the processor to perform a data writing method applied to a flash memory device, wherein the flash memory device comprises a high-speed cache space and a flash memory space, and the high-speed cache space comprises a first cache space and a second cache space, wherein the first cache space is used to cache user data sent by a host, and the second cache space is used to cache user data written into the flash memory space, and wherein the data writing method comprises:
acquiring user data distributed from the host and storing the user data in the first cache space;
writing the user data in the first cache space into the flash memory space;
caching the user data in the second cache space after the user data is written into the flash memory space;
smoothing a write bandwidth of the flash memory space to obtain an average write bandwidth of the flash memory space;
determining a first release bandwidth according to the average write bandwidth of the flash memory space, wherein the first release bandwidth is equal to the average write bandwidth; and
releasing the user data in the second cache space according to the first release bandwidth.

20. The non-transitory computer-readable storage medium according to claim 19, wherein smoothing the write bandwidth of the flash memory space to obtain the average write bandwidth of the flash memory space comprises:
counting a volume of data that is successfully written into the flash memory space in a real-time manner;
determining a plurality of first write bandwidths corresponding to a plurality of sampling durations at least by:
after each sampling duration, counting a data increment of the volume of written data to compute a first write bandwidth corresponding to the sampling duration, wherein the first write bandwidth is computed by dividing the data increment by the sampling duration; and
smoothing the plurality of first write bandwidths by a smoothing algorithm to obtain the average write bandwidth.
